(19) United States
(12) Patent Application Publication
(10) Pub. No.: US 2025/0383258 A1
(43) Pub. Date: Dec. 18, 2025

(54) METHOD SUITABLE FOR GRADIENT SPECTACLE LENS EVALUATION AND CORRESPONDING DEVICE

(71) Applicant: Carl Zeiss Vision International GmbH, Aalen (DE)

(72) Inventors: Filippo Semeraro, Mornago (IT); Matteo Boaretto, Busto Arsizio (IT); Sabrina Malnati, Lozza (IT)

(73) Assignee: Carl Zeiss Vision International GmbH, Aalen (DE)

(21) Appl. No.: 19/325,066

(22) Filed: Sep. 10, 2025

Related U.S. Application Data
(63) Continuation of application No. PCT/EP2024/056871, filed on Mar. 14, 2024.

(30) Foreign Application Priority Data
Mar. 14, 2023 (EP) 23161709.3

(51) Int. Cl. G01M 11/02

(52) U.S. Cl. CPC G01M 11/0285

(57) ABSTRACT

A computer-implemented method suitable for gradient spectacle lens evaluation and a corresponding computer are provided. Measurement data indicating at least one of a color or a transmission of a plurality of measurement points along at least one line across the spectacle lens is received. The method further includes calculating scalar values representing a difference of the measurement data of adjacent or overlapping measurement point groups of the plurality of measurement points. The spectacle lens is then evaluated based on the scalar values.

### CROSS REFERENCE TO RELATED APPLICATIONS

This application is a continuation application of international patent application PCT/EP2024/056871, filed on Mar. 14, 2024 and designating the U.S., which claims priority to European patent application EP 23 161 709.3, filed on Mar. 14, 2023, both of which are hereby incorporated by reference in their entireties.

### TECHNICAL FIELD

The present application relates to computer-implemented methods suitable for evaluation of gradient spectacle lenses and relates to corresponding devices.

### BACKGROUND

Gradient spectacle lenses are lenses which do not have a uniform color, but which have varying color over their surface. Such gradient spectacle lenses may for example be used for sunglasses and typically include one or more darker areas having lower light transmission and one or more lighter areas having higher light transmission. For example, in one type of gradient spectacle lenses for sunglasses, when the sunglasses are worn, the upper part (towards the top of the head in the as worn position), referred to as top part or simply as top, is darker and the lower part, referred to as bottom part or bottom, is lighter, with a transition area inbetween.

When producing such gradient spectacle lenses, e.g., for sunglasses, it is desirable to evaluate if the coloring has been applied to the lenses as per requested specifications, e.g., at the correct position and/or with right width of gradient.

For example, in a typical production process, a production tinting bath is programmed according to a target gradient and the lenses are subjected to a coloring bath accordingly. Then, the actual gradient color applied to the lens is measured and compared with the target, and if the measured gradient does not sufficiently correspond to the target, the lens may be rejected, and/or the production process may be adapted.

Conventionally, the width of gradient color on the lens is measured through visual observation of the lens on a light box with the help of a special ruler. This leads to some amount of subjectivity of the observation, for example, the question where the gradient starts and ends precisely. For example, the human eye is limited in regards to detecting small color variations, which may lead to different measurements depending on the operator being performing the measurements.

The Smart Shade device which used to be provided by Smart Vision, but is no longer on the market, was a special device to analyze gradients of spectacle lenses and which returned a percentual match of surface area with respect to a master gradient lens, without giving any further information on the measured lens. The master gradient lens was a lens which was regarded as a target design, i.e., taken as a lens specimen manufactured as desired.

Therefore, even if defective lenses could be identified due to a low percentage of surface area matching, it was difficult to adapt the production based on this result alone, for example, as no further information could be obtained (e.g., width of darker, transition, and clearer areas and positioning on the lens of these areas). Moreover, it was necessary to identify a reference point on the lens under examination for the measurement and if this reference point was not exactly the same between master lens and sample lens, the Smart Shade device was unable to identify it.

### SUMMARY

Starting from this conventional solution for automatic lens measurement, it is an object underlying the present disclosure to provide an improved method for evaluating gradient spectacle lenses, which is able to give more information about the gradient, for example position of the gradient, and which may be applied to different types of gradient lenses.

“ISO 12311:2013 Personal protective equipment—Test methods for sunglasses and related eyewear” in section 7.2.1.1 describes measurement of uniformity of luminous transmittance for filters with bands or gradients of different luminous transmittance.

“ISO 12312-1:2013 Eye and face protection—Sunglasses and related eyewear—Part 1: Sunglasses for general use” in section 5.3 describes general transmittance requirements.

JP 2009 109442 A describes an eyeglass lens stain inspection method, apparatus, and an eyeglass lens manufacturing method.

JP 2004 326018 A describes a plastic lens dyeing method and ink for plastic lens dyeing used in the method.

DE 10 2013 003558 A1 describes a device and a method for the assessment of the coloring of spectacle lenses.

Starting from the related art, it is an object underlying the present disclosure to provide an improved method for evaluating gradient spectacle lenses.

According to a first aspect of the disclosure, a computer-implemented method suitable for evaluating a gradient spectacle lens is provided, comprising receiving measurement data indicating at least one of color and transmission at a plurality of measurement points along at least one lines across the gradient spectacle lens, characterized by calculating scalar values representing a difference between the measurement data of adjacent or overlapping measurement point groups, each measurement point group including at least one measurement point of the plurality of measurement points, and evaluating the gradient spectacle lens based on the scalar value.

According to a second aspect of the disclosure, a computer-implemented method suitable for evaluating a gradient spectacle lens is provided, comprising receiving measurement data indicating at least one of color and transmission at a plurality of measurement points along at least one lines across the gradient spectacle lens, characterized by calculating scalar values representing a difference between the measurement data of adjacent or overlapping measurement point groups, each measurement point group including at least one measurement point of the plurality of measurement points, and evaluating the gradient spectacle lens based on the scalar value, and further comprising evaluating the gradient spectacle lens by comparing the scalar values to at least one threshold value, and comparing positions along the at least one line where the scalar value crosses the at least one threshold to nominal values.

The receiving of the measurement data may for example be performed by uploading the measurement data to a computer performing the method or to a storage like cloud storage accessible by the computer.

By providing the scalar values, a quantitative evaluation of the gradient spectacle lens is facilitated, as the magnitude of the scalar values directly correlate to the gradient: high scalar value represents a large difference between the measurement data of the adjacent measurements point groups and therefore a large gradient, while low scalar values conversely represent a low gradient.

A scalar is a value which may be represented by a single real number. In contrast, the measurement data indicating color contains a plurality of values per measurement points. To represent a color, at least three values are typically used. For example, the color may be represented in the RGB (red, green, blue) system with three values. Other systems for representing the color may also be used, like the L*a*b color space or the CMY color space. In such cases, the measurement data for each point may be represented as a vector having typically at least three components, which makes an analysis directly based on the measurement data more difficult than the scalar values.

A measurement point group includes one or more measurement points of the plurality of measurement points. For example, in case the at least one line across the spectacle lens is a single line, each group may include one or more adjacent points along the line. Two point groups are adjacent if they immediately follow each other along the direction of the at least one line without having common measurement points, and are overlapping if they include common measurement points. For example, in case of a single line, when each point group includes three measurement points, the group may advance by two points from group to group, such that two successive groups overlap at one point. These are merely some numerical examples. Including more than one measurement point in each point group has the advantage of some smoothing or averaging effects, such that measurement tolerances of the individual measurement points may be a statistical average.

The at least one line may also include two or more parallel lines. In this case, each measurement point group may include one or more points of each line, wherein the points for each line have the same position along a direction of the lines. For example, in some exemplary embodiments between three and seven lines, for example five lines, may be used. A higher number of lines may increase a measurement time needed for capturing the measurement data but may increase the above-mentioned averaging effect and make the measurement more precise. A number of lines between three and seven lines is a good compromise between accuracy of measurement and required measurement time.

Measurement point groups are overlapping if they share one or more measurement points. The term “difference between the measurement data of adjacent or overlapping measurement point groups” also covers cases where more than two measurement point groups are used for calculating the scalar values.

The scalar values essentially constitute a function along the length direction of the at least one line, which may be evaluated in various ways. This function, in other words, represents the scalar values over the position along the line.

In case the measurement data indicates the color, calculating the scalar values may be performed using so-called ΔE_{CMC} (1:1) values. This approach is for example defined in ASTM standard D2244-22 (see in particular equations (21) and (22) thereof), and additional information may be found in ASTM E308-99. The ΔE_{CMC} (1:1) metric defined in the standard has the advantage of providing a standardized and well-understood metric for the color difference. For this, if the measurement data is already the LCh color space (lightness, Chroma and hue), and ΔE_{CMC} (1:1) may be calculated then based on the standard equations given by the standard. If the color is measured in terms of RGB, the conversion to LCh may be via the L*a*b color space defined in EN ISO 116464-4. Other scalar values, also defined in the above standard, may also be used instead of ΔE_{CMC} (1:1), for example ΔE_{CMC} (2:1). The use of ΔE_{CMC} (a:b) values, where a=1 or 2 and b=1, has the advantage that by the selection of a and b also the human perception can be taken into account. Alternatively, ΔE as defined in EN ISO 11664-4 which generally defines the L*a*b* color space may be used. Also these metrics are well-defined standard metrics and are therefore well understood. In yet other exemplary embodiments, the color values may be converted to greyscale values, for example by calculating a greyscale value gs for each measurement point according to gs=(R+G+B)/3, where R, G and B are red, green and blue values, respectively, averaging the greyscale values over the respective measurement point groups and calculating differences between the averaged values of adjacent point groups. In case the measurement data indicates the transmission the same calculation as explained above for greyscale values may be used.

The measurement data may be obtained by conventional measurement devices, for example the UTM 5064 device (uniformity of luminous transmittance) as supplied by AD Engineering.

In some exemplary embodiments where the color is used to calculate the scalar values, nevertheless in addition to the color the measurement data may also indicate the transmission of the gradient spectacle lens at the plurality of measurement points. The transmission, typically averaged over the measurement point groups, may be displayed to a user in addition to e.g., displaying the scalar values or color information. This gives additional information to a user.

For evaluation, the scalar values obtained may be normalized, for example such that the highest scalar value has a value of 1 (or 100%). This facilitates handling of the data, for example the use of generic threshold values as explained below. However, the scalar values may also be evaluated without such a normalization, for example by setting thresholds depending on a maximum value of the scalar values.

As mentioned briefly above, evaluating the spectacle lens based on the scalar values may include comparing the scalar values to one or more thresholds. A scalar value above a threshold indicates a high difference in the measurement data and therefore a transition region where a high color gradient is present, whereas a scalar value defined below a respective threshold indicates a low difference. In this way, various areas may be identified, for example transition areas between certain positions along the at least one line and areas outside the transition area. These areas can be converted in widths with unit of measure in mm and compared with the values (mm) of recorded standard targets and a PASS/FAIL method may be adopted the evaluate the difference of width areas using+/−3 mm of tolerance. For example, in case of a typical gradient lens with a darker top and a lighter bottom, a bottom area a transition area and a top area may be identified. The positions of the area boundaries, which may be where the scalar value crosses the threshold, may then be compared to nominal values for a respective lens type under examination.

Some types of lenses, for example so called Halo lenses which have a lighter inner side and a darker outer side, or so called FOOD lenses which have darker bottom and top parts separated by a lighter inner part, may have more than one transition areas along the at least one line, and the same or different thresholds may be used for different transition areas. The evaluation for different transition areas may also be separated to perform a more precise analysis for each transition areas. In particular, the scalar values may then be normalized for each transition area separately, and in some exemplary embodiments the same threshold value may be used for each (separately normalized) transition area. In other exemplary embodiments, different threshold values may be used.

In an exemplary embodiment, the same threshold value may be used for all normalized scalar values, for example a threshold value between 0.7 and 0.9 (70% and 90%). This makes evaluation easier. In other exemplary embodiments, different threshold values may be used for different lens types.

In some exemplary embodiments, nominal values for the positions of the area boundaries mentioned above may be stored for different lens types. In other exemplary embodiments, they may be input manually. In some exemplary embodiments, the lens type may be provided together with the measurement data, for example read by a corresponding measurement device based on a label of the lens.

For obtaining the measurement data, the lens may be positioned such that the at least one line coincides with a gradient direction. For some kind of lenses like the above mentioned Halo lenses, the at least one line may run essentially through the center of the lens. This ensures that the width of the areas (dark, light, transition) can be reproducibly measured.

In some exemplary embodiments, to assist an operator, a curve representing the color values may be displayed together with the measurement data along the line. Moreover, in some exemplary embodiments color curves as mentioned along the at least one line may be displayed in a color map to give the operator additional information.

Some exemplary embodiments may include a smoothing of the curve represented by the scalar values, for example by applying a low pass filtering. Smoothing the curve may reduce effects from measurement noise and small deviations. In other exemplary embodiments, a curve without smoothing may be evaluated to monitor small scale variations of the differences of measurement data.

In addition, or alternatively to evaluating gradient of a spectacle lens based on one or more threshold values, a deviation of the curve represented by the scalar values may be compared with an ideal curve, either for the whole curve or only for a specific portion of the curve, for example a portion above a further threshold value like 0.5 (50%). For example, in this way a deviation from an ideal transition may be determined. The ideal curve for a transition may be a Gaussian curve (distribution), and a deviation from the curve between the curve given by the scalar values and the Gaussian curve (distribution) may for example be determined according to the following formula:

$${I}_{( GD )} = \frac{{\sum }_{i = 1}^{n} \vert {y}_{i} - {y}_{i}^{′} \vert}{{\sum }_{i = 1}^{n} {y}_{i}^{′}}$$

I_{(GD)} is a deviance index from the reference Gaussian curve. The numerator calculates the sum of the absolute differences between the reference Gaussian curve (y′ᵢ values) and the scalar values yᵢ, e.g., ΔE_{CMC} (1:1) values, in a graph area with Y (vertical axis) greater than the further threshold value, e.g., 0.5. In the denominator the sum of the Y>0.50 of the G curve is calculated.

The I_{(GD)} index has a value of 0% in case of perfect overlapping scalar values and Gaussian curves (best case).

The I_{(GD)} index has a value of 100% in case of maximum difference between the scalar values and the Gaussian curve (worst case).

In an exemplary embodiment, a target curve may comprise or may correspond to the Gaussian curve (distribution). In other exemplary embodiments, other predefined target curves may be used.

Based on the deviation from the ideal curve, a quality measure may be obtained and output (for example a low quality value for a high deviation and correspondingly a high quality value for a low deviation). Likewise, a quality value may be generated based on the deviations of the above-mentioned positions of transitions from nominal positions. Based on the quality values, for example a manufactured lens may be accepted or discarded, and/or in case of low quality values, a manufacturing device may be recalibrated.

Therefore, according to another aspect, a method suitable for producing and controlling gradient spectacle lenses is provided, which comprises manufacturing a gradient spectacle lens, and evaluating the gradient spectacle lens with any of the methods discussed above.

Apart from the measurement discussed above, the method may be implemented as software on a computer device, for example in form of an excel sheet adapted to perform the calculations above. Therefore, a computer program comprising instructions which, when the program is executed by a computer, cause the computer to carry out the methods mentioned above (apart from the measurement itself) is provided. The instructions may be stored in a memory of the computer or other storage in form of a computer program. A computer-readable storage medium having stored thereon such a computer program and a data carrier signal carrying the computer program are also provided. Furthermore, a computer program stored on a non-transitory tangible computer readable storage medium, the computer program comprising instructions which, when the program is executed by a computer, cause the computer to carry out the method as explained above is provided. It should be noted that the term “computer” above does not necessarily imply a single entity, but also more devices may be coupled with each other and exchange data to perform the methods above. For example, the scalar values may be computed on one device, which are then sent to another device for evaluation, for example comparison with threshold values.

According to a further aspect, a device, for example a computer, comprising a processor configured to perform the methods above is provided. A system including a measurement device for obtaining the measurement data and the computer, where the measurement device provides the measurement data to the computer, is also provided.

Furthermore, a data processing system comprising a processor and a storage medium coupled to the processor is provided, wherein the processor is adapted to perform the steps of the method discussed above, based on a computer program stored on the storage medium.

In an exemplary embodiment, a computer-implemented method suitable for evaluating a gradient spectacle lens may comprise receiving, via a first computer interface, measurement data indicating at least one of a color and a transmission of a plurality of measurement points along at least one line across the gradient spectacle lens. The computer-implemented method of this exemplary embodiment may further comprise calculating, by a computer processor, scalar values representing a difference between the measurement data of adjacent or overlapping measurement point groups, each measurement point group including at least one measurement point of the plurality of measurement points. Additionally, in this exemplary embodiment, one measurement point group of the measurement point groups may be associated with a preceding region of the gradient spectacle lens and another measurement point group of the measurement point groups may be associated with a subsequent region of the gradient spectacle lens, wherein the subsequent region may be adjacent to or may overlap with the preceding region. The preceding region may be defined as a spatial region in which measurement points of one measurement point group are located. The subsequent region may be defined as a spatial region in which measurement points of the other (subsequent) measurement point group are located. A scalar value may be calculated for a region that is defined by overlapping or adjacent points of the one and the other measurement point groups. The region for which the scalar value is calculated may identify or correspond to a position value. The preceding and the subsequent regions may be square or rectangular regions comprising a plurality of rows and columns of measurement point of the respective measurement point group. The preceding and the subsequent regions may have the same size. The measurement point group associated with the preceding region and the subsequent measurement point group associated with subsequent region may have the same number of measurement points. The region for which one scalar value is calculated may be rectangular or square. The region for which one scalar value is calculated may have the same shape as the preceding and the subsequent regions. Alternatively, the region for which one scalar value is calculated may have a different shape as compared to the preceding and the subsequent regions. For example, preceding and the subsequent regions may be square (e.g., each comprising 5×5 measurement points located at equal distances from each other) and the region for which one scalar value is calculated may be rectangular (e.g., comprising 3×5 measurement points located at the equal distances from each other). A spatial coordinate corresponding to the central position of the region for which a scalar value is calculated may define a position value for which the scalar value is calculated. Additionally, in this exemplary embodiment, the computer-implemented method may further comprise generating, by the computer processor, a curve of scalar values comprising the scalar values and a plurality of position values, wherein each scalar value from the plurality of scalar values may be associated with a position value from the plurality of position values. Additionally, in this exemplary embodiment, each position value from the plurality of position values may be associated with a region of the gradient spectacle lens located between a preceding region and a subsequent region, wherein the preceding region and the subsequent region may overlap with each other or may be adjacent with each other. Additionally, in this exemplary embodiment, the computer-implemented method may further comprise providing, via a second computer interface, the curve of scalar values for evaluating one or more characteristics of the gradient spectacle lens, and evaluating, by the computer processor, the gradient spectacle lens based on the curve of scalar values. Additionally, in this exemplary embodiment, evaluating the gradient spectacle lens may comprise providing, via a third computer interface, at least one threshold value and at least one corresponding nominal position value for the at least one threshold value, and comparing the scalar values of the curve of scalar values to the at least one threshold value. In this exemplary embodiment, evaluating the gradient spectacle lens may further comprise comparing position values of the plurality of position values along the at least one line where the curve of scalar values crosses the at least one threshold value to the at least one corresponding nominal position value.

Preceding region may be defined as a region from which one measurement point group is obtained. Subsequent region may be defined as a region from which another (subsequent) measurement point group is obtained. Preceding region may overlap with the subsequent region forming region n by overlapping points. Alternatively, preceding region may be adjacent to the subsequent region forming region n by adjacent points. The preceding region and the subsequent region may be regions of a plurality of regions arranged along a line across the lens. Stated differently, one measurement point group may be measured over a preceding region and another measurement point group may be measured over a subsequent region. An overlapping or adjacent region may be defined by overlapping or adjacent points of the measurement point groups. For example, each of preceding region and subsequent region may comprise an array of 5×5 points, wherein the preceding region overlaps with the subsequent region by an array of 3×5 points defining the overlapping region, and wherein an array of 2×5 points of the preceding region and an array of 2×5 points of the subsequent region may be outside of the overlapping region. For example, one scalar value for a region may be calculated based on 5×5+5×5=50 measurement points. And then, a curve of scalar values may be obtained for each position along the at least one line, each position being associated with each region. In an exemplary embodiment, a curve of scalar values can be compared to a target curve and quality measures may be derived based on the deviation between the curves.

In an exemplary embodiment, evaluating the gradient spectacle lens based on the cure of scalar values may further comprise providing, via a fourth computer interface, a plurality of target values and a plurality of position values defining a target curve associated with the gradient spectacle lens, wherein each target value of the plurality of target values may be associated with a corresponding position value of the plurality of position values, and comparing each scalar value of the curve of scalar values at each position value to each value of a target curve at the corresponding position value.

In an exemplary embodiment, the target curve may further comprise a Gaussian distribution of the plurality of target values.

In an exemplary embodiment, a quality measure of a gradient of the gradient spectacle lens may be obtained based on a deviation of at least one of the scalar values of the curve of scalar values from at least one of the plurality of target values of the target curve, wherein the deviation may be calculated by the computer processor.

In an exemplary embodiment, measurement data for evaluating the gradient spectacle lens may be provided via a first computer interface. In an exemplary embodiment, additional data for further evaluating the gradient spectacle (e.g., values associated with target curves, Gaussian distribution, target values, threshold values, nominal position values) may be provided via a second computer interface. The output data resulting from the evaluation may be generated by the computer processor. The output data resulting from the evaluation may be provided via a third computer interface for aiding manufacturing of a gradient spectacle lens.

“Computer processor” may be simply referred to as a “processor”.

“Computer-implemented method” may be simply referred to as “method”.

Technical advantages provided by the features of independent claims in view of the cited prior art may relate to the following.

One improvement of the second aspect may relate to that evaluating the gradient spectacle lens comprises comparing the scalar values to at least one threshold value.

Due to the features of the first and/or second aspects, advantageous combination of evaluating gradient spectacle lenses based on both, transmittance and color may be facilitated.

The features of the second aspect related to comparing positions along the at least one line where the scalar value crosses the at least one threshold to nominal values can provide further advantages for evaluating gradient spectacle lenses making the evaluation more precise, robust and reliable.

Further technical advantages of features specified in the dependent claims in view of the cited prior art may relate to the following.

Advantageously, evaluating the spectacle lens based on the scalar values may further comprise comparing a curve defined by the scalar values over position along the at least one line with a target curve further contributing to the precision, robustness, and reliability of the evaluation.

Evaluating the spectacle lens based on comparing a curve defined by the scalar values over position along the at least one line with a target curve can provide more detailed evaluation of the gradient spectacle lenses because deviation from target positions where the scalar values match the target values for color and/or transmission can be precisely characterized.

Advantageously, the target curve may further comprise a Gaussian distribution. A target curve implemented by Gaussian distribution can provide an ideal evaluation metrics, and thus, comparing positions where a curve defined by the scalar values crosses the target curve implemented by Gaussian distribution can further improve the method for evaluating gradient spectacle lenses.

A quality measure for a gradient of the gradient spectacle lens may be advantageously obtained based on the deviation of the curve of scalar values from the target curve providing another level of detail when evaluating the gradient spectacle lens.

Measurement data comprising color and measurement data comprising transmission can advantageously facilitate evaluation of gradient spectacle lenses based on the combination of color and transmission. Obtaining quality measures based on the combination of the measurement data comprising color and transmission may further benefit evaluation of gradient spectacle lenses, and thus, may aid manufacturing of gradient spectacle lenses.

Obtaining one measurement point group over a preceding region and another measurement point group over a subsequent region may allow for reducing noise in measurement data when evaluating the gradient spectacle lenses based on the measurement point groups.

In an example, evaluating the gradient spectacle lens may comprise. generating a curve of scalar values comprising the scalar values and a plurality of position values, wherein each scalar value from the plurality of scalar values may be associated with a position value from the plurality of position values, and wherein each position value from the plurality of position values may be associated with a region of the gradient spectacle lens located between respective preceding region and respective subsequent region, wherein the respective preceding region and the respective subsequent region overlap with each other or are adjacent with each other. In this exemplary embodiment, the curve of scalar values can provide further improvements in evaluating the gradient spectacle lens. In this exemplary embodiment, evaluating the gradient spectacle lens based on the curve of scalar values can further reduce measurement noise and provide more systematic, reliable and robust evaluation metrics.

### BRIEF DESCRIPTION OF THE DRAWINGS

The disclosure will now be described with reference to the drawings wherein:

FIG. 1 shows a block diagram of a system according to an exemplary embodiment;

FIG. 2 shows a flowchart illustrating a method according to an exemplary embodiment;

FIG. 3 shows a gradient spectacle lens;

FIG. 4 shows an exemplary embodiment process flow for generating scalar data;

FIG. 5 shows an exemplary embodiment for two measurement point groups;

FIG. 6 shows an exemplary embodiment of a measurement graph;

FIG. 7 shows another exemplary embodiment of a measurement graph;

FIG. 8A shows a standard gradient lens;

FIG. 8B shows a measurement graph of the lens of FIG. 8A;

FIG. 9A shows an exemplary embodiment of a Halo lens;

FIG. 9B shows a measurement graph of the lens of FIG. 9A;

FIG. 10A shows an exemplary embodiment of a colored lens;

FIG. 10B shows a first measurement diagram for the lens of FIG. 10A;

FIG. 10C shows the evaluation for a peak of a curve;

FIG. 10D shows another evaluation for a peak of a curve;

FIG. 11 shows a measurement graph and additional information;

FIGS. 12A and 12B show measurement curves and smoothing of the curves; and

FIG. 13 shows a measurement curve and a Gaussian curve.

### DESCRIPTION OF EXEMPLARY EMBODIMENTS

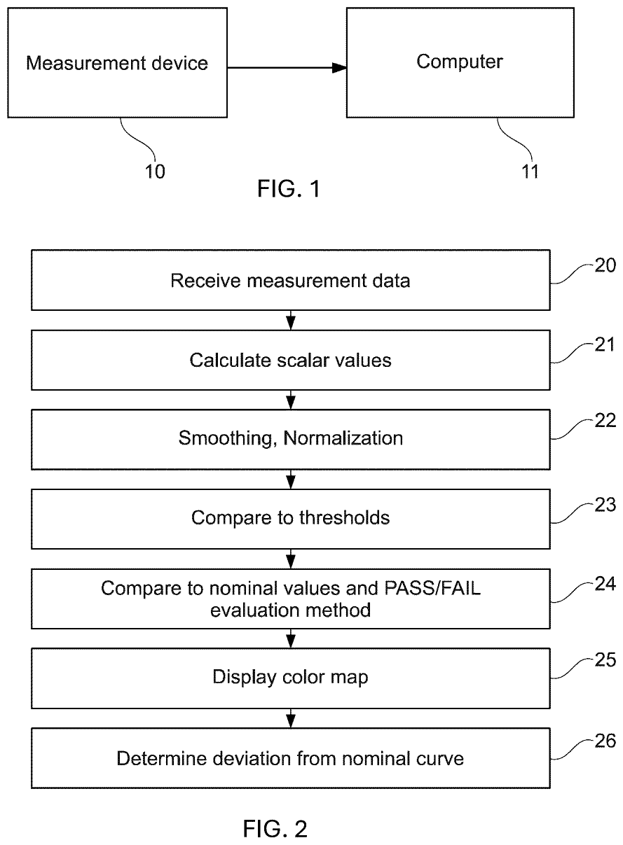

FIG. 1 illustrates a system according to an exemplary embodiment. The system of FIG. 1 includes a measurement device 10 and a computer 11. Measurement device 10 is configured to perform measurements of transmission and color of a gradient spectacle lens along at least one line.

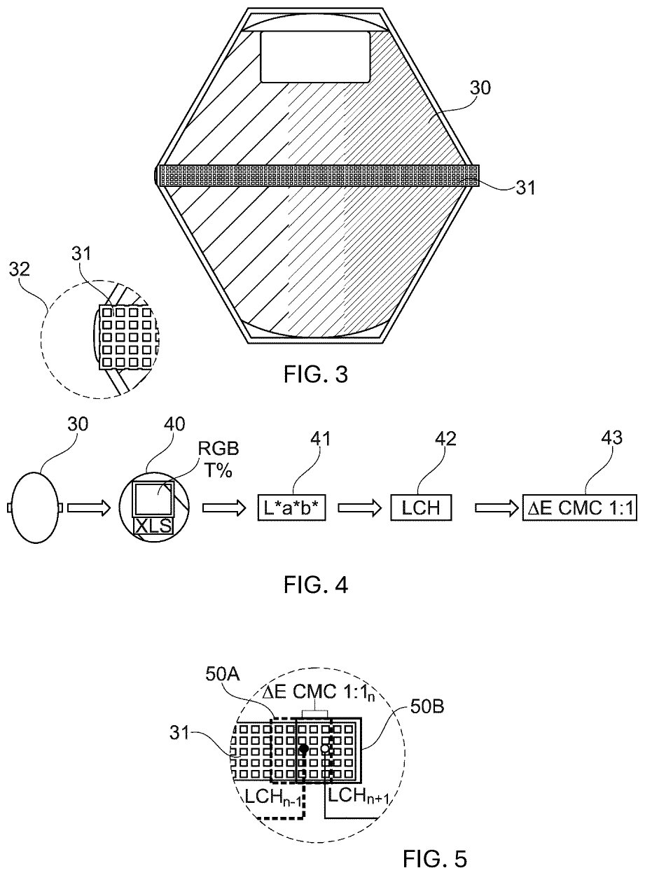

This is illustrated in FIG. 3 showing a gradient spectacle lens 30, where (as can be better seen in inset 32) measurements are performed at measurement points 31 in five parallel lines. The orientation of gradient spectacle lens is such that the lines are parallel to the direction of the gradient, which in FIG. 3 is from left to right. In the exemplary embodiment of FIG. 1, measurement device 10 is the UTM measurement device mentioned above, and provides measurement data in form of RGB values for colors and a value T for the transmission in percent. Returning to FIG. 1, measurement device 10 provides the measurement data to a computer 11. As mentioned above, computer 11 may be a single computer device or may include a plurality of devices communicating with each other. Computer 11 is configured to perform a method as illustrated in FIG. 2, by programming a processor of computer 11 accordingly.

In FIG. 2, in step 20 the method starts with receiving the measurement data from measurement device 10. Receiving the measurement data may be via a direct connection, via the internet, or by transporting the measurement data on a data carrier.

In step 21, the method comprises a step of calculating scalar values based on adjacent or overlapping point groups of the measurement data. An exemplary embodiment will be illustrated referring to FIGS. 4 and 5.

FIG. 4 shows an example process flow for generating scalar data. Based on the gradient spectacle lens 30, measurement data 40 is obtained in the form of RGB values and transmission, T, values. In the exemplary embodiment of FIG. 4, these are provided for each measurement point, for example in form of a table. In the process flow of FIG. 4, this data, by computer 11, is first converted to L*a*b color data 41 and from there to LCh color data 42. Based on the LCh color data 42 then, as scalar values, ΔE_{CMC} (1:1) scalar values 43 are calculated for adjacent or overlapping point groups.

FIG. 5 shows an exemplary embodiment for two measurement point groups 50A, 50B of measurement points 31. In this exemplary embodiment, 5 points of each of the 5 lines shown line form point groups, and successive measurement point groups 50A, 50B (also designated LCHₙ₋₁ and LCHₙ₊₁ in FIG. 5) overlapping by three points are selected, and a value ΔE_{CMC} (1:1) n is calculated and assigned to a region n. Other measurement point groups or also single adjacent points may also be used, but as mentioned above selecting point groups with a plurality of points provide an averaging and reduce measurement noise.

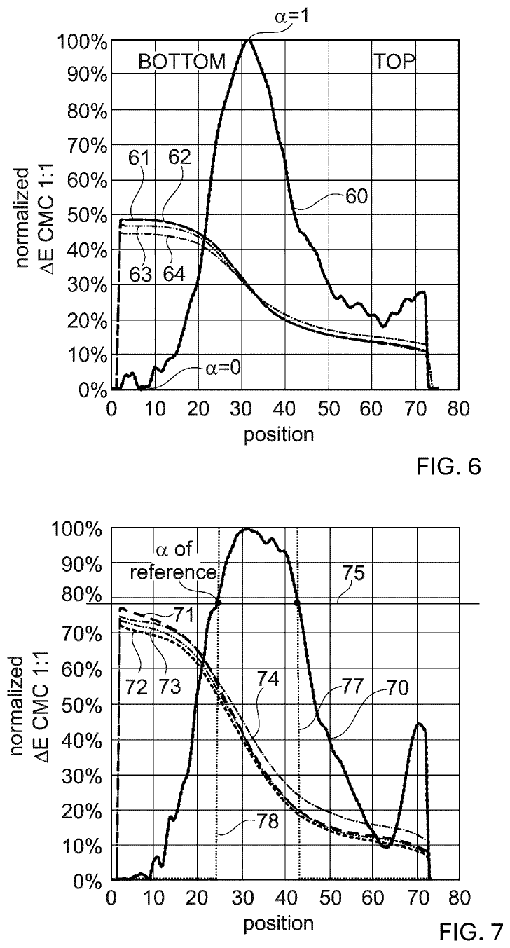

Returning to FIG. 2, at 22 the scalar values may be further processed. One example is a normalization, where the largest scalar value is assigned a value of 1 or 100%. FIG. 6 shows an example measurement graph for a curve 60 of normalized ΔE_{CMC} (1:1) values α with a range from α=0 to α=1 (100%) from bottom to top of a gradient lens. Curves 61 to 64 illustrate the original measurement data, where a curve 61 shows the transparency T, curve 62 shows the red (R) component, curve 63 shows the green (G) component, and curve 64 shows the blue (B) component. As can be seen, curve 60 reaches at its peak (α=1) about in the middle of the transition of curves 61-64 from comparatively high to comparatively low values. Therefore, curve 60 can be used as a quantitative measure of the gradient. The ripples that can be seen on the left and right sides of the curves are due to measurement noise or tinting tolerances. Due to such ripples, in some exemplary embodiments scalar values under 30% of a maximum scalar value are disregarded.

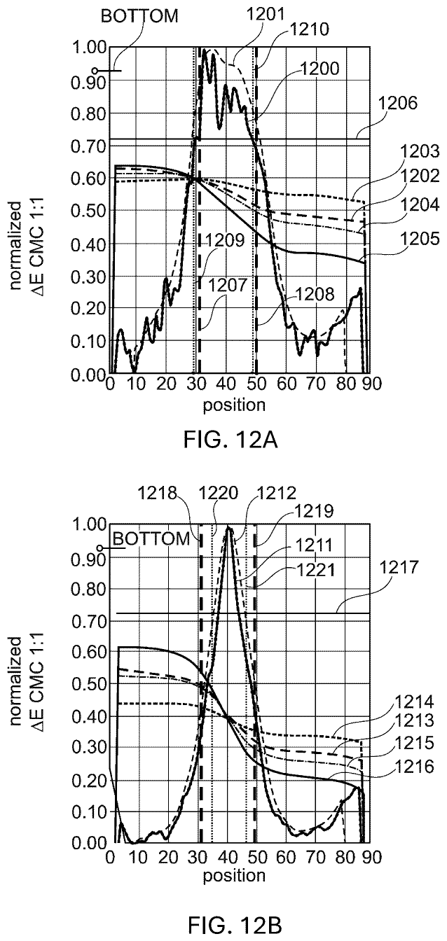

Smoothing is illustrated in FIG. 12A where a curve 1200 of the scalar values calculated is smoothed by filtering to a curve 1201, and in FIG. 12B, where a curve 1211 of scalar values is smoothed to a curve 1212. The remainder of FIGS. 12A and 12B will be explained further below.

Returning to FIG. 2, the scalar values, possibly after normalization or smoothing, in step 23 are compared to threshold values. A simple example is shown in a measurement graph FIG. 7, where a curve 70 represents the scalar values, a curve 71 represents the measure transmission, and curves 72-74 represent measured red, green, and blue values, respectively. A threshold value represented by a line 75 is set as a of reference. The points where curves 70 cross line 75 are marked by dashed vertical lines 78, 77, which represent boundaries between areas of the gradient lens. To the left of line 78, at the “bottom” there is a light, highly transparent area, between lines 78 and 77 there is the transition area with high differences between successive groups of measurement points, and to the right of line 77 there is the dark area at the top of the lens. Therefore, using curve 70 and by selecting a corresponding value for the α of reference according to line 75 the corresponding sections of the lens may be quantitatively determined.

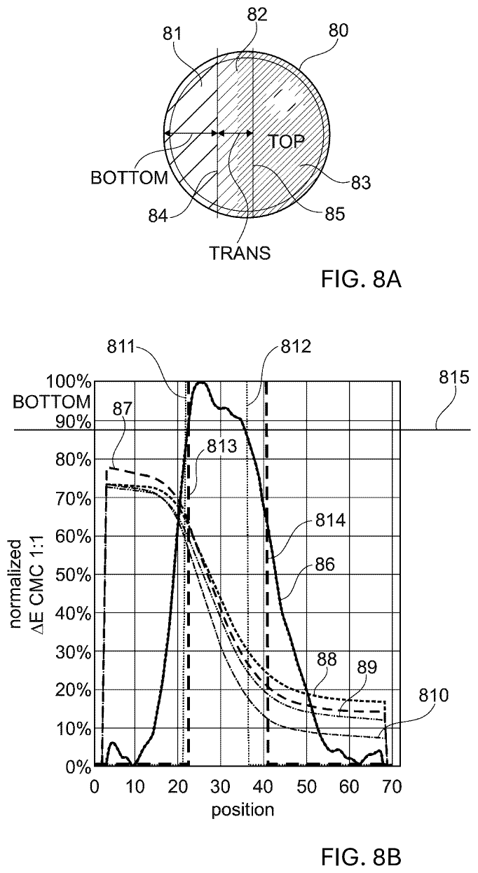

In step 24 of FIG. 2, the positions where the scalar values cross the threshold(s) (in case of FIG. 7 the positions indicated by line 77, 78) may be compared to nominal values. This will be illustrated with respect to FIGS. 8A, 8B, 9A, 9B, and 10A to 10D for different types of gradient lenses. A PASS/FAIL method as explained above is then employed.

FIG. 8A shows a standard gradient lens 80 with a lighter bottom area 81, a transition area 82 and a darker top area 83, where the lighter bottom area 81 is separated from transition area 82 by a line 84 and transition area 82 is separated from top area 83 by a line 85 (the lines are only for illustration and not present in the actual lens). In use, the lighter bottom area 81 is worn at the bottom, and the darker area is worn at the top, even if they are represented left to right in FIG. 8A (and similar representations are used in the following drawings)

FIG. 8B shows an example measurement graph of the lens of FIG. 8A. A curve 86 shows the normalized ΔE_{CMC} (1:1) values, as has been explained previously for curve 60 and 70 of FIGS. 6 and 7. A curve 87 shows the transmission, and curves 88-810 show the measurement result for red, green and blue components, respectively, similar to what has been explained for curve 61-64 of FIG. 6.

A line 815 denotes the threshold value, corresponding to line 75 of FIG. 7. Vertical dashed lines 811 and 812 illustrate where curve 86 crosses line 815, corresponding to lines 78 and 77 of FIG. 7.

Vertical lines 813 and 814 show nominal positions of the boundaries of the transition area. As can be seen, the position of dashed line 811 in this exemplary embodiment coincides well with line 813, whereas dashed line 812 deviates from line 814. The amount of the deviation may be taken as a measure of the quality of the lens. The position of lines 813 and 814 may for example be determined based of specifications for the respective lens or by measuring a lens (e.g., master lens) which has been evaluated as correct by other means, for example the conventional measurement using a ruler.

The threshold value as indicated by line 815 is selected such that lines 811 and 812 denote the position of lines 84 and 85 of FIG. 8A, i.e., the boundaries of transition area 82.

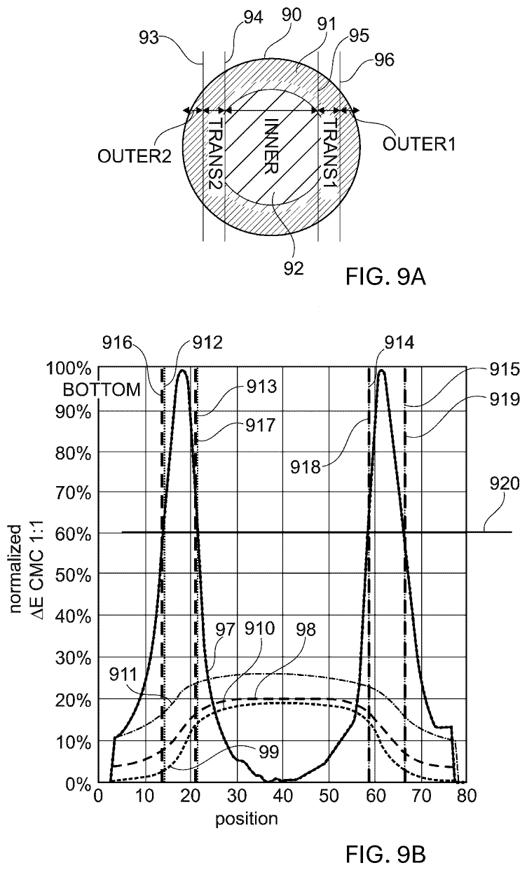

FIGS. 9A and 9B show an exemplary embodiment for a so called Halo lens. FIG. 9A shows an example Halo lens 90 having an essentially circular lighter inner area 92 and a ring-shaped darker outer area 91, separated by a ring-shaped transition area. When measuring along a line, as shown in FIG. 9A two transition areas TRANS1 and TRANS2 appear to be present, once when transitioning from ring-shaped darker outer area 91 to circular lighter inner area 92 and the other when transitioning back from circular lighter inner area 92 to ring-shaped darker outer area 91, which are in fact parts of the same ring-shaped transition area which is crossed twice. A transition area TRANS2 is bounded by lines 93 and 94, and a transition area TRANS1 is bounded by line 95 and 96 in FIG. 9A.

FIG. 9B shows a corresponding measurement graph. A curve 97 illustrates the normalized ΔE_{CMC} (1:1) values over position along the measurement lines, a curve 98 illustrates the transmission, and curves 99, 910 and 911 illustrate the red, green and blue values, respectively. As can be seen, curve 97 has two peaks, corresponding to two transition areas TRANS1 and TRANS2, which are crossed when measuring along a line.

A line 920 illustrates a threshold value for the normalized ΔE_{CMC} (1:1) values. Dashed lines 912, 913 denote where curve 97 crosses line 920 for the first peak (for example ideally corresponding to the positions of lines 93 and 94 of FIG. 9A), and dashed lines 914 and 915 denote where curve 97 crosses line 920 at the second peak, corresponding to the positions of lines 95, 96 of FIG. 9A.

Lines 916 and 917 for the first transition area and lines 918 and 919 for the second transition area denote nominal values. In this case, the nominal values mostly coincide with the measured values, with the exception of line 912 showing a slight deviation from line 916. This is therefore an exemplary embodiment where the lens may receive a good quality rating.

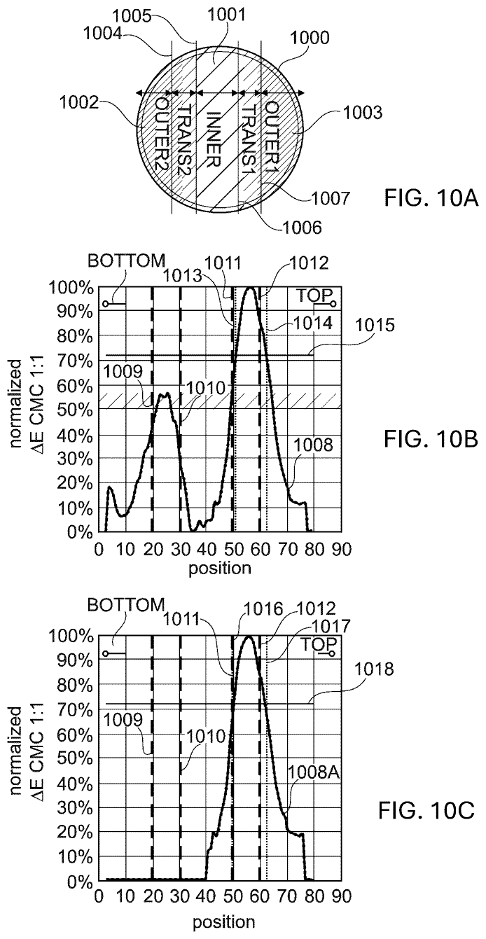

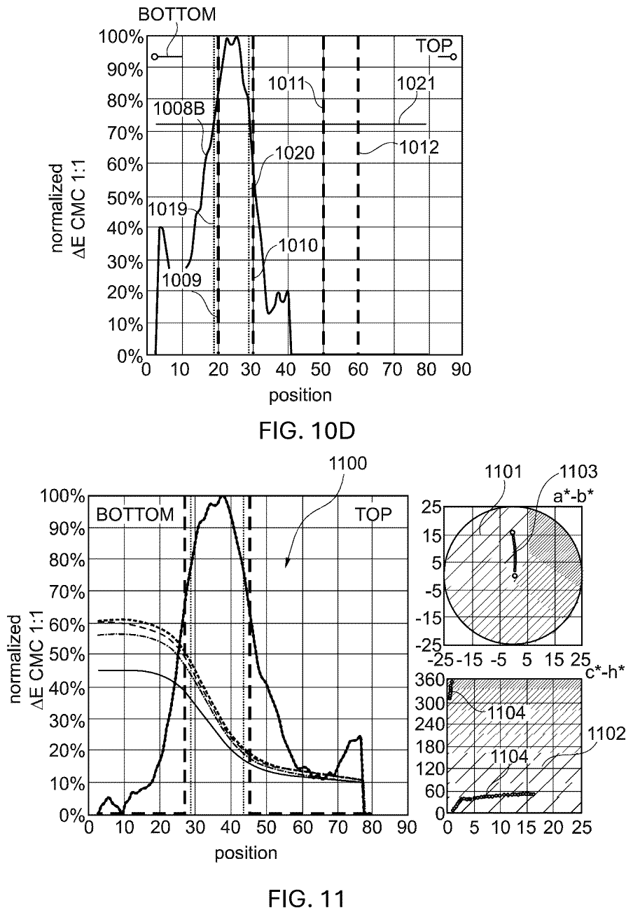

FIGS. 10A and 10B show an exemplary embodiment for a lens 1000 with a different kind of coloring. This lens at the top and bottom has dark areas 1002, 1003, and an inner lighter area 1001. In contrast to the lens 900 of FIG. 9A, the areas are not circular, but as shown in FIG. 10A follow each other from top to bottom and extend over the respective width of the lens. The dark area 1002 is separated from inner lighter area 1001 via a transition area TRANS2, and inner lighter area 1001 is separated from dark area 1003 by a transition area TRANS1. Lines 1004, 1005 on one side and 1006, 1007 on the other side denote the boundaries of the transition areas.

FIG. 10B shows a first measurement diagram for lens 1000 of FIG. 10A. A curve 1008 shows the normalized ΔE_{CMC} (1:1) values over position. Lines 1009 and 1010 show nominal positions of the boundary of transition area TRANS2 of FIG. 10A, corresponding to the nominal positions of lines 1004, 1005 of FIG. 10A, and lines 1011, 1012 show nominal positions of the boundary of transition area TRANS1 of FIG. 10A, i.e., corresponding to the nominal positions of lines 1006, 1007 of FIG. 10A. A nominal position refers to the position according to the design of the lens as intended.

A line 1015 denotes the threshold value when using a single threshold. As can be seen, here only the right peak of curve 1008 intersects line 1015, resulting in dashed lines 1013 and 1014 representing the measured positions of the boundaries of transition area TRANS1, with some deviations from the nominal position 1011, 1012.

For transition area TRANS2, the peak of curve 1008 is lower, and therefore does not intersect line 1015. On the other hand, using a value which intersects both peaks would result in a too broadly measured transition area TRANS1 (right peak).

Therefore, in the exemplary embodiment shown in FIGS. 10C and 10D, the peaks are evaluated separately, with different threshold values and/or normalized separately. Features already discussed with reference to FIG. 10B bear the same reference numerals in FIGS. 10C and 10D and will not be discussed again.

FIG. 10C shows the evaluation for the right peak of curve 1008 of FIG. 10B, the part of the curve corresponding to the right peak being denoted by curve 1008A. A line 1018 corresponds to the reference value, and dashed lines 1016 and 1017 correspond to the positions where curve 1008A crosses line 1018, i.e., the measured positions of the boundaries of transition area TRANS1. The threshold value denoted by line 1018 may correspond to the threshold value denoted by line 1015.

FIG. 10D shows the evaluation for the left peak of curve 1008. The corresponding curve portion is denoted by curve 1008B in FIG. 10D. A line 1021 denotes the threshold value. In the exemplary embodiment of FIG. 10B, curve 1008B is normalized to 1 or 100% for its peak value. In this case, effectively the same reference value may be used as in FIG. 10C, but due to the different scaling factors for normalization this also effectively corresponds to using different threshold values. Here, the positions where curve 1008B crosses line 1021 are shown with dashed lines 1019 and 1020, which in this case coincide well with the nominal values according to lines 1009, 1010. In this way, both transition areas may be reliably measured.

Returning to FIG. 2, in step 25 as additional information to an operator, two dimensional graphs of the color coordinates with curves according to the measured values may be displayed in addition to the measurement graphs discussed above. FIG. 11 shows a corresponding exemplary embodiment. Here, reference numeral 1100 generally denotes the measurement graph, which may be any of the measurement graphs discussed previously with respect to FIG. 6, 7, 8B, 9B, or 10B to 10D. In addition, in fields 1101 and 1102 the color coordinates along the lines measured are represented. In field 1101, the color coordinates are shown in terms of a*-b* of the L*a*b color space, and a curve 1103 shows the corresponding values obtained based on the measurement values (red, green, blue values). Field 1102 shows the color as C-h of the LCh color space, and a curve 1104 shows the color along the measured one or more lines based on the measurement results. In this way, an operator can better visualize the color transition.

FIGS. 12A and 12B show the already discussed smoothing of the curve, together with the measurement values and the evaluation. In FIG. 12A, in addition to curves 1200 and 1201 already discussed, a curve 1202 denotes the measured transmission, and curves 1203, 1204 and 1205 denote the measured red, green, and blue values. In case of a plurality of lines, these values may be an average for the lines, for example the five lines of FIGS. 3 and 5.

A line 1206 denotes the threshold values. Both FIGS. 12A and 12B show exemplary embodiments for standard gradient lenses similar to the one shown in FIG. 8A, i.e., with a single transition. In FIGS. 12A, lines 1207 and 1208 show the nominal positions of the boundaries of the transition area, and dashed lines 1209, 1210 show the values obtained by measuring where the smoothed curve 1201 crosses line 1206 representing the threshold.

FIG. 12B shows another exemplary embodiment, where a curve 1213 denotes the measured transmission, and curves 1214, 1215, and 1216 denote the measurement for the red, green and blue color components. In some exemplary embodiments, the smoothing is only used for lenses where the transition area has a certain minimum width, for example at least 10 mm.

A line 1217 denotes the threshold. Lines 1218 and 1219 denote the nominal positions of the transition areas, and dashed lines 1220 and 1221 denote the positions of the boundary as obtained by the measurement. As can be seen, in this case the transition area is smaller than according to the nominal values.

With the above measurements, the position of transition areas may be determined and compared to nominal values. As mentioned above, in addition or alternatively, in step 26 of FIG. 2, the quality of the gradient of the transition area may be determined.

For example, a perfect gradient, in terms of normalized ΔE_{CMC} (1:1), may correspond to a Gaussian curve, the general formula of which is

$$f ( x ) = \frac{1}{\sqrt{2 π {σ}^{2}}} {e}^{- \frac{{( x - μ )}^{2}}{2 {σ}^{2}}}$$

where σ² is the variance and μ is the center value. For the gradient, μ, as measured form the bottom, corresponds to the width of the bottom+half the width of the transition area (for a standard gradient lens) and σ is equal to the width of the transition area x the reference value used x a constant, which may be set to 14/17 The constant that helps to better identify σ of the Gaussian curve, and 14/17 has turned out to be a suitable value.

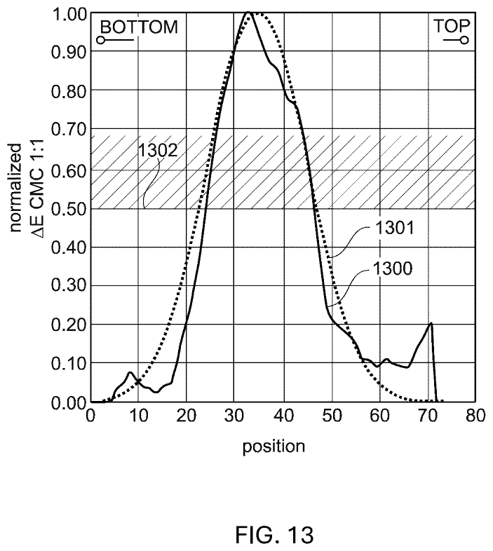

The function f gives values corresponding to the ΔE_{CMC} (1:1) values for positions x (lens diameter/lens height if the lens is squared). This Gaussian curve may be compared to the measured values of nominalized ΔE_{CMC} (1:1), as shown in FIG. 13.

In FIG. 13, a curve 1300 corresponds to the normalized ΔE_{CMC} (1:1), and a curve 1301 corresponds to the Gaussian curve (distribution). In some exemplary embodiments, if the above formula does not fit, σ and μ may be manually adjusted. For comparing the curves, it is possible to calculate the Deviance index from the reference Gaussian curve as described above. The area (integral) of the curves is evaluated for values greater than a threshold value, for example greater than 0.5, (i.e., above line 1302) may be determined. The deviance index may be translated into a percentage values, and the quality may be measured based on this Deviance index. For example, the quality may be defined as follows:
0-5% excellent
5-10% good
10-15% acceptable
15-20% mediocre
>20% very bad

The above threshold values are merely examples, and other values may be selected.

Any one of line 75 in FIG. 7, line 815 in FIG. 8B, line 920 in FIG. 9B, line 1015 in FIG. 10B, line 1018 in FIG. 10C, line 1021 in FIG. 10D, line 1302 in FIG. 13, and/or line 1206 in FIG. 12A (indicating predetermined threshold values) may be referred to as a target curve. A target curve may comprise curve 1301 corresponding to the Gaussian curve (distribution) as described in the context of FIG. 13.

In an exemplary embodiment, measurement data 40 illustrated in FIG. 5 may be received via a first computer interface (not shown in FIG. 5). Scalar values 43 illustrated in FIG. 5 may be calculated by a computer processor (not shown in FIG. 5). The gradient spectacle lens 30; 80; 90; 1000 in FIGS. 3, 8A, 9A, and 10A, respectively, may be evaluated by a computer processor (not shown in FIGS. 3, 8A, 9A, and 10A).

Returning to FIG. 5, a region n, a preceding region (n−1) and a subsequent region (n+1) are illustrated in FIG. 5 Preceding region (n−1) corresponds to the region where measurement point group 50A is located, and subsequent region (n+1) corresponds to the region where measurement point group 50B is located. In FIG. 5, preceding region (n−1) overlaps with the subsequent region (n+1) forming region n, i.e., region n is the region where the preceding region (n−1) and the subsequent region (n+1) overlap. In FIG. 5, preceding region (n−1) is indicated by a rectangle marked up by the dashed line and associated with measurement point group 50A. Region (n+1) is indicated in FIG. 5 by a rectangle marked up by the solid line and associated with measurement point group 50B. Measurement point group 50A is measured over preceding region (n−1) and r measurement point group 50B is measured over a subsequent region (n+1). FIG. 5 illustrates preceding region (n−1) and subsequent region (n+1) each comprising an array of 5×5 measurement points, wherein the preceding region (n−1) overlaps with the subsequent region (n+1) by an array of 3×5 points defining the overlapping region n, and wherein an array of 2×5 points of the preceding region (n−1) and an array of 2×5 points of the subsequent region (n+1) are outside of the overlapping region n. For example, as illustrated in FIG. 5, one scalar value for a region (n) may be calculated based on 5×5+5×5=50 measurement points. And then, a scalar value may be obtained for each position associated with each region (n), thus resulting in a curve of scalar values vs position along a line across the spectacle lens. The position is the center position of region n in a horizontal direction in FIG. 5. A curve of scalar values can be compared to a target curve and quality measures may be derived based on the deviation between the curves.

As illustrated in FIGS. 4 and 5, the scalar values 43 may represent the difference between the measurement data 40 of the overlapping measurement point groups 50A, 50B of the respective preceding region (n−1) and subsequent region (n+1), each measurement point group 50A, 50B including at least one measurement point of the plurality of measurement points 31, wherein the subsequent region (n+1) may be adjacent to the preceding region (n−1).

As illustrated in FIGS. 4 and 5, the scalar values 43 represent the difference between the measurement data 40 of the overlapping measurement point groups 50A, 50B, each measurement point group 50A, 50B including twenty five measurement points forming the plurality of measurement points 31, wherein the subsequent region (n+1) overlaps with the preceding region (n−1) by fifteen points of each of the measurement point groups 50A, 50B, and wherein an overlap between the subsequent region (n+1) and the preceding region (n−1) forms an overlapping region (n) comprising said fifteen points, and wherein ten points of each of the measurement point groups 50A, 50B are outside of the overlapping region.

FIG. 5 shows an exemplary embodiment, where the at least one line comprises five parallel lines, and each of the adjacent measurement point groups 50A, 50B comprises five measurement points from each of the parallel lines amounting to twenty five measurement points in each measurement point group 50A, 50B.

FIG. 5 shows an exemplary embodiment, where the measurement data 40 indicates the color, and the scalar values 43 comprise ΔE_{CMC} (1:1) values. In other exemplary embodiments, the measurement data 40 may indicate the color and the transmission (t), and the scalar values 43 may comprise ΔE_{CMC} (1:1) or ΔE_{CMC} (2:1) values and a difference between the transmission (Δt) defined by the difference between the measurement data 40.

The curve of scalar values may be compared to any one of target curves described in the context of line 75 in FIG. 7, line 815 in FIG. 8B, line 920 in FIG. 9B, line 1015 in FIG. 10B, line 1018 in FIG. 10C, line 1021 in FIG. 10D, line 1302 in FIG. 13 and/or line 1206 in FIG. 12A. Each line 75 in FIG. 7, line 815 in FIG. 8B, line 920 in FIG. 9B, line 1015 in FIG. 10B, line 1018 in FIG. 10C, line 1021 in FIG. 10D, line 1302 in FIG. 13, and/or line 1206 in FIG. 12A indicating predetermined threshold values may be referred to as a target curve. In an exemplary embodiment, a target curve may also comprise curve 1301 corresponding to the Gaussian curve (distribution) as described in the context of FIG. 13.

One possible way of carrying out the claimed disclosure may be defined by the following clauses.

Clause 1. A computer-implemented method suitable for evaluating a gradient spectacle lens, comprising:
receiving measurement data (40) indicating at least one of color and transmission of a plurality of measurement points (31) along at least one line across the gradient spectacle lens (30; 80; 90; 1000), characterized by:
calculating scalar values (43) representing a difference between the measurement data of adjacent or overlapping measurement point groups (50A, 50B), each measurement point group (50A, 50B) including at least one measurement point of the plurality of measurement points, and evaluating the gradient spectacle lens (30; 80; 90; 1000) based on the scalar values.

Clause 2. The method of clause 1, characterized in that evaluating the gradient spectacle lens comprises comparing the scalar values to at least one threshold value.

Clause 3. The method of clause 2, further characterized by comparing positions along the at least one line where the scalar value crosses the at least one threshold to nominal values.

Clause 4. The method of any one of clauses 1-3, characterized in that evaluating the spectacle lens based on the scalar values further comprises comparing a curve defined by the scalar values over position along the at least one line with a target curve.

Clause 5. The method of clause 4, characterized in that the target curve comprises a Gaussian distribution.

Clause 6. The method of clause 4 or 5, characterized by further comprising obtaining a quality measure of a gradient of the gradient spectacle lens based on the deviation of the curve of scalar values from the target curve.

Clause 7. The method of any one of clauses 1-6 characterized in that the at least one line comprises a plurality of parallel lines, and each of the adjacent measurement point groups (50A, 50B) comprises at least one measurement point from each of the plurality of lines.

Clause 8. The method of any one of clauses 1-7, characterized in that the measurement data indicates the color, and the scalar values comprise one of ΔE_{CMC} (1:1) or ΔE_{CMC} (2:1) values.

Clause 9. A method suitable for producing gradient spectacle lenses, comprising:
manufacturing a gradient spectacle lens, and evaluating the gradient spectacle lens with the method of any one of clauses 1-8.

Clause 10. A computer program comprising instructions which, when the program is executed by a computer, causes the computer to carry out the method of any one of clauses 1-9.

Clause 11. A computer-readable storage medium storing the computer program of clause 10.

Clause 12. Data carrier signal carrying the computer program of clause 10.

Clause 13. Device comprising a processor configured to perform the following steps:
receiving measurement data (40) indicating at least one of color and transmission of a plurality of measurement points (31) along at least one line across the gradient spectacle lens (30; 80; 90; 1000), characterized by:
calculating scalar values (43) representing a difference between the measurement data of adjacent or overlapping measurement point groups (50A, 50B), each measurement point group (50A, 50B) including at least one measurement point of the plurality of measurement points, and
evaluating the gradient spectacle lens (30; 80; 90; 1000) based on the scalar values.

Clause 14. The device of clause 13, characterized in that evaluating the gradient spectacle lens based on the scalar values further comprises comparing a curve defined by the scalar values over position along the at least one line with a target curve.

Clause 15. The device of clause 13 or 14, characterized in that evaluating the gradient spectacle lens comprises comparing the scalar values to at least one threshold value.

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

1. A computer-implemented method for evaluating a gradient spectacle lens, the method comprising:
receiving measurement data indicating at least one of a color and a transmission of a plurality of measurement points along at least one line across the gradient spectacle lens, wherein the at least one line coincides with a gradient direction of the gradient spectacle lens,
calculating scalar values representing a difference between the measurement data of adjacent or overlapping measurement point groups, each measurement point group including at least one measurement point of the plurality of measurement points, and evaluating the gradient spectacle lens based on the scalar values,
wherein the scalar values form a curve representing a function along a length direction of the at least one line, and wherein evaluating the gradient spectacle lens includes comparing the curve of scalar values to at least one threshold value and comparing positions along the length direction of the at least one line where the curve of scalar values crosses the at least one threshold to nominal values.

2. The method of claim 1, wherein the nominal values define a nominal position of a transition region.

3. The method of claim 1, wherein the method further comprises normalizing the curve of scalar values, wherein the at least one threshold value is the same for different lens types.

4. The method of claim 1, wherein evaluating the spectacle lens based on the curve of scalar values further comprises comparing the curve of scalar values with a target curve.

5. The method of claim 4, further comprising obtaining a quality measure of a gradient of the gradient spectacle lens based on the deviation of the curve of scalar values from the target curve.

6. The method of claim 1, wherein the at least one line includes a plurality of parallel lines, and each of the adjacent measurement point groups includes at least one measurement point from each of the plurality of lines.

7. The method of claim 1, wherein the measurement data indicates the color, and the scalar values include one of ΔE_{CMC} (1:1) or ΔE_{CMC} (2:1) values calculated according to ASTM standard D2244-22.

8. The method of claim 1, wherein one measurement point group of the measurement point groups is located in a preceding region of the gradient spectacle lens and another measurement point group of the measurement point groups is located in a subsequent region of the gradient spectacle lens, wherein the subsequent region is adjacent to or overlaps with the preceding region.

9. The method of claim 8, wherein the scalar values represent the difference between the measurement data of the adjacent measurement point groups, each measurement point group including at least one measurement point of the plurality of measurement points, and wherein the subsequent region (n+1) is adjacent to the preceding region.

10. The method of claim 8, wherein the scalar values represent the difference between the measurement data of the overlapping measurement point groups, each measurement point group including at least two measurement points of the plurality of measurement points,
wherein the subsequent region overlaps with the preceding region by at least one point of each of the measurement point groups, wherein an overlap between the subsequent region and the preceding region forms an overlapping region associated with the region, and wherein at least one point of each of the measurement point groups is outside of the overlapping region.

11. A method suitable for producing gradient spectacle lenses, the method comprising: manufacturing a gradient spectacle lens, and evaluating the gradient spectacle lens with the method of claim 1.

12. A computer program comprising instructions which, when the computer program is executed by a computer, causes the computer to carry out the method of claim 1.

13. A computer-readable storage medium storing the computer program of claim 12.

14. A device for evaluating a gradient spectacle lens comprising a processor configured to perform the following steps:
receiving measurement data indicating at least one of color and transmission of a plurality of measurement points along at least one line across a gradient spectacle lens,
wherein the at least one line coincides with a gradient direction of the gradient spectacle lens;
calculating a plurality of scalar values representing a difference between the measurement data of adjacent or overlapping measurement point groups, each measurement point group including at least one measurement point of the plurality of measurement points; and
evaluating the gradient spectacle lens based on the scalar values,
wherein the scalar values form a curve representing a function along a length direction of the at least one line, and wherein evaluating the gradient spectacle lens comprises comparing the curve of scalar values to at least one threshold value and comparing positions along the length direction of the at least one line where curve of scalar values crosses the at least one threshold to nominal values.
